(19) United States
(12) Patent Application Publication
(10) Pub. No.: US 2006/0014633 A1
(43) Pub. Date: Jan. 19, 2006

(54) Catalyst compositon for olefin polymerization

(76) Inventors: Herwig Schottenberger, Patsch (AT); Adrian G Mueller, Innsbruck (AT); Klaus Wurst, Innsbruck (AT); Nicolaas H Friederichs, Brunssum (NL); Bing Wang, Geleen (NL); Edwin Ijpeij, Sittard (NL)

Correspondence Address: MAYER, BROWN, ROWE & MAW LLP, 1909 K STREET, N.W., WASHINGTON, DC, 20006, US

(21) Appl. No.: 10/518,935

(22) PCT Filed: Jun. 26, 2003
(86) PCT No.: PCT/NL03/00472

§ 371 Date: Aug. 31, 2005

Related U.S. Application Data
(60) Provisional application No. 60/419,966, filed on Oct. 22, 2002.

(30) Foreign Application Priority Data
Jun. 28, 2002 (EP) 02077590.4

(51) Int. Cl. B01J 31/00; C07F 5/00; C07F 3/06

(52) U.S. Cl. 502/150; 502/167; 556/118; 534/11; 534/15

(57) ABSTRACT

The invention relates to a catalyst composition comprising a salt of a non- or weakly coordinating anion, said non- or weakly coordinating anion comprising at least one metal or metalloid ion M with valency v+, v representing an integer between 1 and 5, and at least one bidentate ligand coordinating to this metal or metalloid ion, and a catalyst that can be activated by said non- or weakly coordinating anion, characterized in that said bidentate ligand is a bidentate monoanionic ligand of formula (I): (R¹_{q}A¹-X-A²R²ᵣ), wherein X represents a bridging moiety; A¹ and A² are each independently chosen from the group comprising N, O, P, S, and C; R¹ and R² are each independently chosen from the group comprising an optionally substituted linear or branched (hetero)alkyl group, an optionally substituted (hetero)aryl group, and a Si containing group; and q and r each independently represent an integer with 0≦q, r≦2.

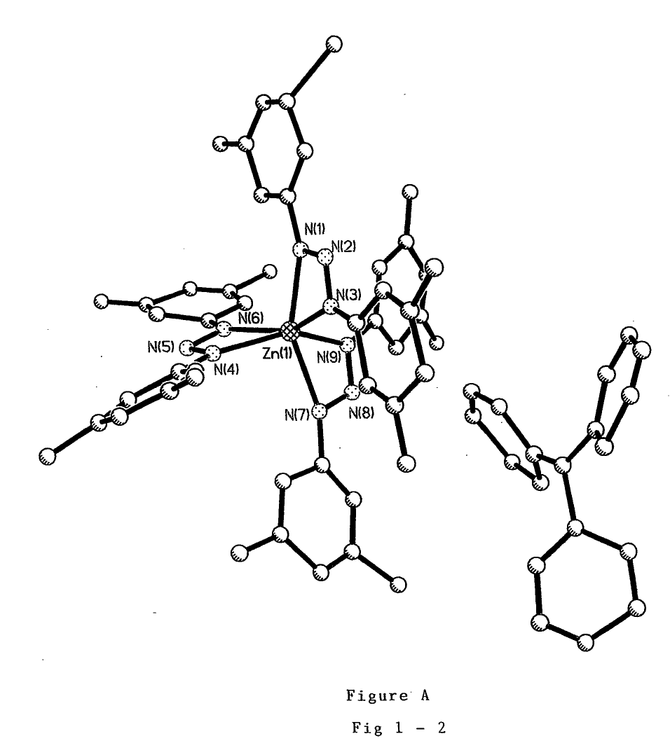

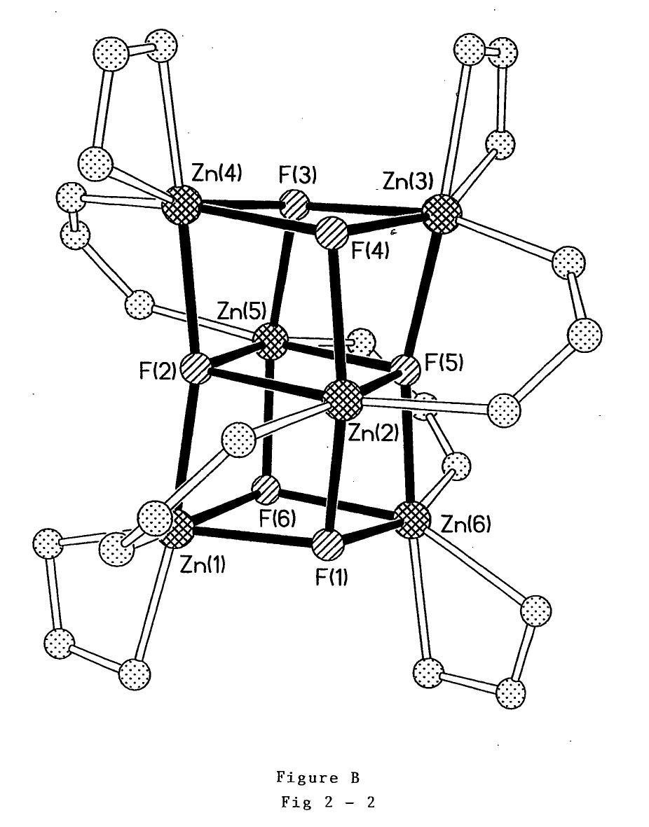

The invention relates to a catalyst composition comprising a salt of a non- or weakly coordinating anion, said non- or weakly coordinating anion comprising at least one metal or metalloid ion M with valency v+, v representing an integer between 1 and 5, and at least one bidentate ligand coordinating to this metal or metalloid ion, and a catalyst that can be activated by said non- or weakly coordinating anion. The invention also relates to a process for the polymerization of olefins in the presence of said catalyst composition, to the preparation of a compound comprising a C) non- or weakly coordinating anion, and to compounds comprising a non- or weakly coordinating anion.

Non- or weakly coordinating anions are applied in catalyst compositions to activate or enhance the activity of transition metal catalysts, for example in olefin polymerisation.

In single site catalysis, in particular in metallocene catalysis, methyl aluminoxanes (MAO's), which, after alkyl aluminium chlorides, are known as “second generation” co-catalysts, are generally applied for this purpose. MAO, however, has a number of disadvantages. First of all, the synthesis of MAO involves the use of the precursor trimethyl aluminium, which is highly pyrophoric and has a high cost price. Furthermore, a large stoichiometric excess of MAO over the catalyst, i.e. ranging from several hundreds to ten thousands, is required to obtain a reasonable catalytic activity.

In the 1990's discrete non- or weakly coordinating anions were developed for application in catalyst compositions comprising single site catalysts. Such discrete non- or weakly coordinating anions are known as “third generation” co-catalysts. In contrast to MAO, such anions proved to be very efficient while utilizing a 1:1 catalyst:cocatalyst ratio. Well known examples of such “third generation” non- or weakly coordinating anions are B(C₆F₅)₄⁻, B(C₆H₃(CF₃)₂)₄⁻, B(C₆F₅)₃R⁻, and B(C₆H₃(CF₃)₂)₃R⁻, wherein R usually represents an alkyl group. Said anions may be available as salts, but may also be formed in situ in the polymerization mixture from a neutral compound, for example B(C₆F₅)₃, and a alkylated transition metal compound by transfer of the alkyl group from this compound to B(C₆F₅)₃.

A disadvantage of said anions is that their synthesis involves precursors with a limited stability. For example, β-halo-organometal compounds like the precursor C₆F₅Li may violently decompose under the formation of LiF and highly reactive benzynes. In order to avoid such decomposition, the synthesis of said anions requires special precautions.

The abstraction of LiF and the formation of toxic benzynes can be prevented by avoiding the use of β-halo-organometal compounds as a precursor. This is demonstrated in for example Y. Sun et al., “Al-, Nb-, and Ta-based Perfluoroaryloxide Anions as Co-catalysts for Metallocene-Mediated Ziegler-Natta Olefin Polymerization”, Organomet., 19 (2000) 1625-1627 (“Sun et al.”). In this article sterically encumbered metalloid and transition metal counter anions based on the pentafluorophenoxide group C₆F₅O⁻ are disclosed, for example Al(OC₆F₅)₄⁻, Nb(OC₆F₅)₆⁻ and Ta(OC₆F₅)₆⁻. Such compounds are prepared by reacting C₆F₅OH with LiAlH₄, as such providing a relatively simple process form the production of non- or weakly coordinating anions. The perfluoroaryloxide anions mentioned above were found to yield active ethylene polymerization catalysts in combination with sterically encumbered zirconocene dimethyl complexes.

A disadvantage of the counter anions as disclosed in Sun et al. is the fact that, although such anions used in combination with sterically encumbered zirconocene dimethyl complexes offer a high ethylene polymerization activity, this activity is not paralleled by propylene polymerization activity.

The aim of the present invention is therefore to provide a catalyst composition comprising a non- or weakly coordinating anion, the catalyst composition being also suitable for propylene based homo- and copolymerizations.

This is achieved according to the invention by using a catalyst composition comprising a salt of a non- or weakly coordinating anion, said non- or weakly coordinating anion comprising at least one metal or metalloid ion M with valency v+, v representing an integer between 1 and 5, and at least one bidentate monoanionic ligand coordinating to this metal or metalloid ion of Formula (I):
(R¹_{q}A¹-X-A²R²ᵣ)⁻, (1)
wherein
X represents a bridging moiety;
A¹ and A² are each independently chosen from the group comprising N, O, P, S, and C;
R¹ and R² are each independently chosen from the group comprising an optionally substituted linear or branched (hetero)alkyl group, an optionally substituted (hetero)aryl group, and a Si containing group; and
q and r each independently represent an integer with 0≦q, r≦2.

Surprisingly catalyst compositions comprising a salt of such a non- or weakly coordinating anion were found to be capable of catalyzing the homo- and copolymerization of propylene and can therefore be applied in a broader field of olefin polymerization processes.

In the catalyst composition the non- or weakly coordinating anion is generally present as a salt, in combination with a cation. This salt may also be formed in situ. It may be formed for example during a polymerization process, by the abstraction of a negatively charged leaving group, for example an alkyl group, from another species in the reaction mixture, for example a catalyst, by a neutral compound comprising a bidentate monoanionic ligand of formula (R¹_{q}A¹-X-A²R²ᵣ)⁻.

The charge of the bidentate monoanionic ligand of formula (R¹_{q}A¹-X-A²R²ᵣ)⁻ is preferably delocalized over the moiety A¹-X-A², as is the case for example when A¹-X-A² represents N—N, N—CR³—N or P—N—P, R³ being chosen from the group comprising an optionally substituted linear or branched (hetero)alkyl group, an optionally substituted (hetero)aryl group, and a Si containing group. Delocalization of the charge over the A¹-X-A² is illustrated by the crystal structure of tritylium tris{1,3-bis[3,5-bis(trifluoromethyl)phenyl]triazenido} zincate(II) (Figure A). The Zn—N distances for the six Zn—N coordination bonds are all in the range of 2.128-2.188 Å, which illustrates that the monoanionic bidentate ligand acts in a symmetric delocalized manner, providing withdrawal of electron density, and electron delocalization over the entire metallate complex.

X represents a bridging moiety. Preferable X comprises an atom chosen from the group comprising C, N, O, S, and P. More preferably X respresents N or CR³, R³ being defined as above.

Preferably A¹ and A² are each independently chosen from the group comprising C, N, O, S and P. More preferably A¹ and A² each represent N.

If a catalyst composition or a compound according to the invention comprises more than one bidentate monoanionic ligand according to the formula (R¹_{q}A¹-X-A²R²ᵣ)⁻, said ligands may be the same or different.

R¹ and R² are each independently chosen from the group comprising an optionally substituted linear or branched (hetero)alkyl group, an optionally substituted (hetero)aryl group, and a Si containing group. Suitable substituents are inert under the applied polymerization conditions and include for example a halogen, an hydroxy group, an amine group, an amide group, a thiol group, an alkoxy group with for example 1 to 20 C atoms, a (hetero)aryl group with for example 1 to 20 C atoms and an aryloxy group with for example 1 to 20 C atoms. Preferably R¹ and R² each independently represent a halogenated hydrocarbyl group, more preferably a fluorinated hydrocarbyl group. The parameters q and r, representing the number of R¹ and R² groups bound to A¹ and to A², respectively, depend on the nature of A¹ and A².

In particular (R¹_{q}A¹-X-A²R²ᵣ)⁻ represents (R⁵N—NR⁶)⁻, wherein R⁵ and R⁶ are each independently chosen from the group defined above for R¹ and R²; (R⁸—C(O)—CR⁹═C(O)—R¹⁰)⁻, wherein R⁸, R⁹ and R¹⁰ are each independently chosen from the group defined above for R¹ and R²; or (R¹¹—N═CR¹²—N—R¹³), wherein R¹¹, R¹² and R¹³ are each independently chosen from the group defined above for R¹ and R².

In a catalyst composition according to the invention M preferably represents a metal from any one of Groups 2, 3, 4, 5, 6, 7, 8, 9, 10, 11 and 12 of the Periodic System of Elements, or an actinide or lanthanide metal. The Periodic System of Elements is understood to be the new IUPAC version as printed on the inside cover of the Handbook of Chemistry and Physics, 70th edition, CRC Press, 1989-1990. More preferably M is selected from Zn, Mn, and Mg. Most preferably M represents Zn.

In the catalyst composition according to the invention, the salt of the non- or weakly coordinating anion also comprises a cation. This cation is preferably chosen from the group comprising Li⁺; K⁺; Na⁺; H⁺; triphenylcarbenium; R⁷₃Si, wherein R⁷ respresents an optionally substituted linear or branched (hetero)alkyl group, an optionally substituted (hetero)aryl group, or a Si containing group; an optionally substituted tropylium salt, an optionally substituted silver salt; anilinium; ammonium; a substituted ammonium cation, in which at most three hydrogen atoms have been replaced by a hydrocarbyl radical having 1-20 carbon atoms; a substituted hydrocarbyl radical having 1-20 carbon atoms, in which one or more of the hydrogen atoms has or have been replaced by a halogen atom; a phosphonium radical; a substituted phosphonium radical, in which at most three hydrogen atoms have been replaced by a hydrocarbyl radical having 1-20 carbon atoms; and a substituted hydrocarbyl radical having 1-20 carbon atoms, in which one or more of the hydrogen atoms has or have been replaced by a halogen atom. More preferably the cation is N,N-dimethylanilinium, R⁷₃Si, triphenylcarbenium, or Li⁺.

In particular the catalyst composition according to the invention comprises a non- or weakly coordinating anion according to Formula (II):
[LₙM(R¹_{q}A¹-X-A²R²ᵣ)ₘ]^{w-} (II)
wherein
M, X, A¹, A², R¹, R², q, r, and v are defined as above;
L represents a ligand to M or a bridging moiety between two M atoms;
n is an integer with 0≦n≦5;
m is an integer with 1≦m≦6;
n+m>v;
n+m≦6;
w is an integer with 1≦w≦3;
the ligands (R¹_{q}A¹-X-A²R²ᵣ) may be the same or different;
   or an anion being a cubane of formula (III)
   [L¹_{z1}L²_{z2}Mₓ(R¹_{q}A¹-X-A²R²ᵣ)_{y}]^{w-} (III)
   wherein
M, X, A¹, A², R¹, R², q, r, v, and w are defined as above;
L¹ is an end-capped or corner-bridging bidentate ligand;
L² is a core building ligand;
x is an integer with 2≦x≦10;
y is an integer with 0≦y≦20;
z1 and z2 are integers with 0≦z1, z2≦20;
y+z1+z2>xv; and
the ligands (R¹_{q}A¹-X-A²R²ᵣ)⁻ may be the same or different.

Preferably an eightfold triazenide-complexed hexafluoro, hexazincate face fused dicubane is used, for example tetrakis-μ-[1,3-η-(1,3-bis-(3,5-bis(trifluoromethyl)phenyl)triazenido)]-tetrakis-[1,3-η-(1,3-bis-(3,5-bis(trifluoromethyl)phenyl)triazenido]-tetra-(μ³-fluoro)-di-(μ⁴-fluoro)-hexazincate²⁻, bistritylium salt.

In the compounds of Formula (II) and (III), L, L¹ and L² each independently represent a neutral or anionic ligand to M or a bridging moiety between two M atoms. Examples of L, L¹ and L², which may be the same or different, are a hydrogen atom, a halogen atom, an alkyl group, an aryl group, an aralkyl group, an alkoxy group, an aryloxy group, a group with a heteroatom chosen from Group 14, 15 or 16 of the Periodic System of Elements, such as an nitrogen containing group, for example an amine group, amide group or a imidazolyl group, a sulphur-containing compound, for example a sulphide or a sulphite, a phosphorus-containing compound, for example a phosphine and a phosphite, and an oxygen containing group, for example hexafluoropentane-2,4-dionate and perfluoro-1,2-dihydroxy benzene. The ligands L, L¹ and L² may also be a monoanionic ligand bonded to M via a covalent metal-carbon bond and which is additionally capable to non-covalently interact with M via one or more functional groups. Generally L is a monoanionic ligand, preferably a fluoro or chloro ligand or a methyl group. If L is anionic, the number of L groups in the compound of Formula (II), defined as n, is determined by v (valency of M), the valency of L, m and w according to |v+w−m/valency L|. For example when M=Zn²⁺, w=1 (monoanion), m=2, and L=methyl, the number of methyl groups is 1. In the anion of formula (III) L¹ is for example hexafluoropentane dionate, L² is for example a halogen, preferably fluoro.

Generally the catalyst present in the catalyst composition is a transition metal catalyst, preferably a single site catalyst, more preferably a single site catalyst comprising a metal chosen from the group comprising Ti, Zr, Hf, V, Fe, Pd, Ni, Cr, Co, Cu, and Ru.

In the catalyst composition according to the invention, the molar ratio of the non- or weakly coordinating anion relative to the catalyst is usually in a range of from about 1:100 to about 1,000:1, and preferably is in a range of from about 1:2 to about 250:1.

As a person skilled in the art is aware, the non- or weakly coordinating anion as well as the catalyst that can be activated by said anion can be present in the catalyst composition as a single component or as a mixture of several components. For instance, a mixture may be desired where there is a need to influence the molecular properties of the polymer, such as the molecular weight and in particular the molecular weight distribution.

The invention also relates to a process for the polymerization of olefins, wherein at least one catalyst composition according to the invention is used.

The invention relates in particular to a process for the polymerisation of (an) α-olefin(s). The α-olefin(s) is/are preferably chosen from the group comprising q ethylene, propylene, butene, pentene, hexene, heptene and octene, while mixtures can also be used. More preferably, ethylene and/or propylene is/are used as α-olefin. The use of such olefins may lead to the formation of crystalline polyethylene homopolymers and copolymers of both low and high density, for example High Density PolyEthylene (HDPE), Low Density PolyEthylene (LDPE), Linear Low Density PolyEthylene (LLDPE), said polyethylene polymers having a weight average molecular weight, as measured by Size Exclusion Chromatography (SEC), of less than 800,000 g/mol, and ultra-high molecular weight polyethylene (UHMWPE), the UHMWPE having a weight average molecular weight, as measured by SEC, of more than 800,000 g/mol; p polypropylene homopolymers and copolymers, for example PolyPropylene (PP), Random Copolymer Polypropylene (RCP) and Elastomer Modified PolyPropylene (EMPP). The monomers needed for such products and the processes to be used are known to the person skilled in the art. The process according to the invention is also suitable for the preparation of amorphous or rubbery copolymers based on ethylene and at least one other α-olefin. Propylene is preferably used as the other α-olefin, so that Ethylene Propylene Monomer (EPM) rubber is formed. It is also possible to use a diene besides ethylene and the other α-olefin, so that a so-called Ethylene-α-olefin-Diene Monomer (EADM) rubber is formed, in particular Ethylene Propylene Diene Monomer (EPDM) rubber.

The catalyst composition according to the invention can be used supported as well as non-supported. The catalyst compositions may be supported adhesively or covalently. Supported catalysts are used mainly in gas phase and slurry processes. The carrier used may be any carrier known as carrier material for catalysts, for instance silica, alumina, MgCl₂ or polystyrene.

Polymerisation of the olefin can be effected in a known manner, in the gas phase as well as in a liquid reaction medium. In the latter case, both solution and suspension polymerisation are suitable, while the quantity of transition metal to be used generally is such that its concentration in the dispersion agent amounts to 10⁻¹¹-10⁻⁴ mol/l, preferably 10⁻⁹-10⁻⁵ mol/l.

The process according to the invention will hereafter be elucidated with reference to a polypropylene preparation known per se, which is representative of the olefin polymerisations meant here. For the preparation of other polymers on the basis of an olefin the reader is expressly referred to the Examples.

The preparation of polypropylene relates to a process for homopolymerization or copolymerisation of propylene with one or more olefins having 2-12 carbon atoms and optionally one or more non-conjugated dienes. The olefins that are suitable in particular are ethylene, butene, hexene and octene. Suitable dienes are for instance 1,7-octadiene and 1,9-decadiene.

In a solution or suspension polymerization, any liquid that is inert relative to the catalyst system can be used as dispersion agent in the polymerisation. One or more saturated, straight or branched aliphatic hydrocarbons, such as butanes, pentanes, hexanes, heptanes, pentamethyl heptane or mineral oil fractions such as light or regular petrol, naphtha, kerosene or gas oil are suitable for that purpose. Aromatic hydrocarbons, for instance benzene and toluene, can be used, but because of their cost as well as on account of safety considerations, it will be preferred not to use such solvents for production on a technical scale. In polymerisation processes on a technical scale, it is preferred therefore to use as solvent the low-priced aliphatic hydrocarbons or mixtures thereof, as marketed by the petrochemical industry. If an aliphatic hydrocarbon is used as solvent, the solvent may yet contain minor quantities of aromatic hydrocarbon, for instance toluene. Drying or purification is desirable if such solvents are used; this can be done without problems by the average person skilled in the art.

A solution polymerisation is preferably carried out at temperatures between 150° C. and 250° C.; in general, a suspension polymerisation takes place at lower temperatures, preferably below 170° C.

Hydrogen may suitably be applied as a molecular weight regulator.

The polymer solution resulting from the polymerisation can be worked up by a method known per se. In general the catalyst is de-activated at some point during the processing of the polymer. The de-activation is also effected in a manner known per se, e.g. by means of water or an alcohol. Removal of the catalyst residues can mostly be omitted because the quantity of catalyst in the polymer, in particular the content of halogen and transition metal is very low now owing to the use of the catalyst system according to the invention.

Polymerisation can be effected at atmospheric pressure, but also at an elevated pressure of up to 500 MPa, continuously or discontinuously. If the polymerisation is carried out under pressure the yield of polymer can be increased additionally, resulting in an even lower catalyst residue content. Preferably, the polymerisation is performed at pressures between 0.1 and 25 MPa. Higher pressures, of 100 MPa and upwards, can be applied if the polymerisation is carried out in so-called high-pressure reactors. In such a high-pressure process the catalyst according to the present invention can also be used with good results.

The polymerisation can also be performed in several steps, in series as well as in parallel. If required, the catalyst composition, temperature, hydrogen concentration, pressure, residence time, etc. may be varied from step to step. In this way it is also possible to obtain products with a wide molecular weight distribution.

The invention further relates to a process for the preparation of a compound of formula (IV):
[C]^{c+}ₗ[LₙM(R¹_{q}A¹-X-A²R²ᵣ)ₘ]^{w-} (IV)
wherein
M, X, A¹, A², R¹, R², q, r, v, L, n, m and w are defined as for the compound of formula (II);
[C]^{c+} is a cation;
c 1 or 2;
l is an integer with 1≦l≦3;
l=w/c, and
the ligands (R¹_{q}A¹-X-A²R²ᵣ)⁻ may be the same or different.

According to this process the compound of formula (IV) is prepared comprising the following steps:
i) contacting an alkylated compound comprising the unit MR⁸ₜ, wherein R⁸ is an optionally substituted linear or branched (hetero)alkyl group, an optionally substituted (hetero)aryl group, or a Si containing group, and t is an integer with 1≦t≦4, with (R¹_{q}A¹-X-A²R²ᵣ)H to form a compound of formula M(R¹_{q}A¹-X-A²R²ᵣ)ᵤR⁸ₜ₋ᵤ, wherein u is an integer with 1≦u≦4;
ii) contacting (R¹_{q}A¹-X-A²R²ᵣ)H with [K]^{k+}Hₖ in a solvent that is not capable of donating an electron pair, to form (R¹_{q}A¹-X-A²R²ᵣ)ₖ[K]^{k+}, wherein K is an alkali or alkaline earth metal, and k is 1 or 2
iii) contacting the product obtained in i) with the product obtained in ii), resulting in the formation of [K]^{k+}ₗ[LₙM(R¹_{q}A¹-X-A²R²ᵣ)ₘ]^{w-}
iv) exchanging [K]^{k+} for [C]^{c+}, resulting in the formation of [C]^{c+}ₗ[LₙM(R¹_{q}A¹-X-A²R²ᵣ)ₘ]^{w-}.

Steps i) and ii) may be performed independently in any order.

The reaction step ii) involves a heterogeneous deprotonation. Such heterogeneous deprotonation reaction, in which the use of electron pair donors is avoided, results in a clean formation of compounds of formula (R¹_{q}A¹-X-A²R²ᵣ)ₖ[K]^{k+}. Examples of suitable solvents are optionally substituted linear or branched aliphatic compounds and optionally substituted aromatic compounds. Preferably an aromatic compound is used, more preferably toluene.

Reaction step iv) may be carried out before or after reaction step iii). In the first case, the compound of formula (R¹_{q}A¹-X-A²R²ᵣ)ₖ[K]^{k+}, obtained in step ii), is subjected to direct ion exchange of K, optionally in a one pot procedure, with a salt of the targeted counterion [C]^{c+}, preferably with a [BF₄]⁻ salt of [C]^{c+}, leading to precipitation of the insoluble [K]^{k+} salt and the formation of (R¹_{q}A¹-X-A²R²ᵣ)_{c}[C]^{c+}, which can be used in step iii). In the second case, the compound of formula [K]^{k+}ₗ[LₙM(R¹_{q}A¹-X-A²R²ᵣ)ₘ]^{w-}, obtained in step iii), is subjected to direct ion exchange of K, optionally in a one pot procedure, with a salt of the targeted counterion [C]^{c+}, preferably with a [BF₄]⁻ salt of [C]^{c+}, leading to precipitation of the insoluble [K]^{k+} salt and the formation of [C]^{c+}ₗ[LₙM(R¹_{q}A¹-X-A²R²ᵣ)ₘ]^{w-}.

The invention also relates to a novel compound of formula (V):
[C]^{c+}ₗ[LₙM(R⁵—N—N—R⁶)ₘ]^{w-} (V)
wherein
M, L, n, m, [C]^{c+}, c, l and w are defined as for the compound of formula (IV);
R⁵ and R⁶ are each independently chosen from the group comprising an optionally substituted linear or branched (hetero)alkyl group, an optionally substituted linear or branched (hetero)aryl group, and a Si containing group.

A schematic drawing of the crystal structure of tritylium tris{1,3-bis[3,5-bis(trifluoromethyl)phenyl]triazenido zincate (II) is given in Figure A.

The invention also relates to a novel compound of formula (VI):
[C]^{c+}ₗ[L¹_{z1}L²_{z2}Mₓ(R⁵N—N—N—R⁶)_{y}]^{w-} (VI)
wherein
M, R⁵, R⁶, [C]^{c+}, c, l and w are defined as for the compound of formula (V);
L¹, L², z1, z2, x, y, and v are defined as for the compound of formula (III);
the ligands (R¹_{q}A¹-X-A²R²ᵣ)⁻ may be the same or different.

L¹ is for example hexafluoropentane dionate, L² is for example a halogen, preferably fluoro.

A schematic drawing of the crystal structure of tetrakis-μ-[1,3-η-(1,3-bis-(3,5-bis(trifluoromethyl)phenyl)triazenido)]-tetrakis-[1,3-η-(1,3-bis-(3,5-bis(trifluoromethyl)phenyl)triazenido]-tetra-(μ³-fluoro)-di-(μ⁴-fluoro)-hexazincate²⁻, bistritylium salt is given in Figure B.

The compounds according to formula (V) and (VI) are particularly suitable for use as a non- or weakly coordinating anion in the polymerisation of olefins, for example in the process according to the invention. Said compounds may also be (Fj used for other purposes, for example as an electrolyte, as a counter ion in (asymmetric) homogeneous hydrogenation reactions, as a counter ion in lithium catalysed Diels Alder reactions, in photoinduced cationic polymerization of epoxides, in polymerization reactions of carbon monoxide and ethylene, in litihum catalyzed Friedel-Crafts benzylation reactions, in ionic liquid reaction media, or in fluorous phase organic synthesis.

### EXAMPLES

Starting Materials

3-Methylbutyl nitrite was obtained from Fluka. 3,5-Bis(trifluoromethyl)aniline (97%) was obtained from Aldrich.

### Example I

### Preparation of 1,3-bis[3,5-bis(trifluoromethyl)phenyl]triazene

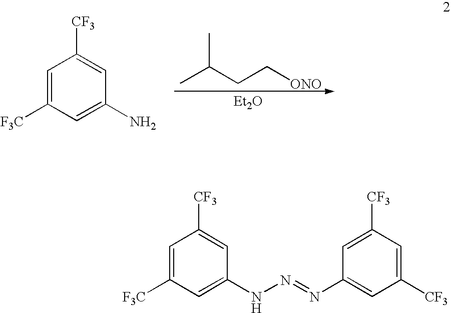

3,5-Bis-(trifluoromethyl)aniline (22.91 g, 100 mmol) was dissolved in 200 ml of anhydrous diethyl ether, and cooled to 0° C. Subsequently, 3-methylbutyinitrite (isoamylnitrite, 23.43 g, 200 mmol) was added dropwise over a period of 10 min. Subsequently, the cooling bath was removed and the mixture was stirred for another 4 hours, while reaching room temperature. The resulting reaction mixture was first extracted with 100 ml of a saturated aqueous solution of NaHCO₃, then two times with a saturated aqueous solution of NH₄Cl, and finally two times with brine. The organic layer was dried over Na₂SO₄ and filtered. The filtrate was evaporated by means of a rotary evaporator and the remainder recrystallized once in 100 ml of methanol, and subsequently in 100 ml of n-hexane, yielding 14.88 g (63.4%) of white crystals. Analytical data: mp: 137-138° C., sublimation under atmospheric pressure at about 70° C. Spectroscopy: IR: 3330(st), 3099 (m), 1623 (st), 1520 (st), 1486 (st), 1457 (st) (in cm⁻¹). MS and NMR are consistent with the chemical structure. The X-ray structure determination shows that the atom connectivity and elemental composition are in accordance with the targeted structure.

### Example II

### Preparation of Potassium 1,3-bis[3,5-bis(trifluoromethyl)phenyl]-triazenide (suspension in toluene)

2.345 g (5.0 mmol) of 1,3-bis-(3,5-bis-(trifluormethyl)phenyl)triazene (Example I) was dissolved in 50 ml toluene and cooled to 0° C. To the resulting suspension were added 1.05 mole equivalents of solid potassium hydride at once. After agitation at 0° C. for 15 min. the cooling bath was removed and stirring was continued for another two hours, while slight evolution of hydrogen took place. For completion of the reaction, stirring was continued for 15 min under heating to 100° C. by means of an oil bath. The resulting suspension was allowed to cool to ambient temperature. This suspension is suitable for direct use in the further steps (Example IV). For analytical purposes the potassium salt may be separated by Schlenk-filtration and washed free from toluene by hexane. Analytical data: X-ray structure determination: atom connectivity and elemental composition in accordance with targeted structure.

### Example III

### Preparation of {1,3-bis[3,5-bis(trifluoromethyl)phenyl]triazenido}zinc(II)

1,3-Bis-(3,5-bis-(trifluormethyl)phenyl)triazene (4.69 g, 10.0 mmol) (Example I) was dissolved in 100 ml of anhydrous toluene and cooled to 0° C. by means of an external ice bath. Subsequently, diethyl zinc (0.503 mole equivalents, 1 molar solution in hexane) was added at once via cannula. Subsequently the cooling bath was removed and stirring of the reaction mixture was continued at ambient temperature for another 2 h. The resulting suspension was then stirred at 100° C. in an oil bath until a clear solution was formed (ca 5 min). The resulting partial product suspension in toluene is suitable for direct use in further steps, for example in Example IV. For analytical purposes or complex formation with other additional donor ligands, the solvent free product may be isolated by prolonged heating above 100° C. and removal of toluene by means of an oil pump (vacuum line). X-ray structure determination: atom connectivity and elemental composition in accordance with targeted structure.

### Example IV

### Preparation of potassium tris{1,3-bis[3,5-bis(trifluoromethyl)phenyl] triazenido} zincate (II)

The hot solution of {1,3-bis[3,5-bis(trifluoromethyl)phenyl]triazenido} zinc(II), as obtained in Example III, was combined with a suspension (temp. 20° C.) of potassium 1,3-bis[3,5-bis(trifluoromethyl)phenyl]triazenide (5 mmoles in 50 ml toluene, as obtained in Example II). The resulting mixture was stirred in an oil bath at 100° C. for 30 min. Afterwards, the reaction mixture was cooled to −30° C., resulting in a product suspension suitable for use in further steps, e.g. in cation exchange reactions as in Example V).

### Example V

### Preparation of tritylium tris{1,3-bis[3,5-bis(trifluoromethyl)phenyl]triazenido} zincate (II)

To a cooled suspension of potassium tris{1,3-bis[3,5-bis(trifluoromethyl)phenyl]-triazenido} zincate (II), as obtained in Example IV, a solution of tritylium tetrafluoroborate (5.0 mmol in 30 ml of CH₂Cl₂) was added via dropping funnel while stirring. After removal of the cooling bath, the reaction mixture was stirred for another 16 h. After settling of the precipitated potassium tetrafluoroborate, the supernatant was decanted and reduced in volume to 60% at 50° C. The resulting mixture was stored for 5 h without agitation at −30° C., whereupon a dark oil separated. This crude product holds preferably and persistantly dichloromethane as solvate constituent, but may be suitable for further use as cocatalytical activator composition. In order to prepare solvent free salt as solid and analytically pure material, further treatment (lowered yields) is required as follows:

The supernatant was decanted again, and the remainder taken up in 30 ml of toluene and ultrasonicated for 3 min in a cleaning bath. Afterwards the product is again stored for 5 h at −30° C. The supernatant was again decanted from the resulting precipitate. The solid material obtained was taken up in 30 ml of toluene and stirred for 10 min in an oil bath at 80° C. The resulting solution was allowed to cool to ambient temperature, with the Schlenk tube still immersed in the oil bath, and without stirring, within a period of 2 h. Subsequently, the resulting mixture was stored for another 12 h at −30° C. Finally, the separated solid was filtered, washed with 10 ml of anhydrous toluene, and dried under the vacuum line by means of an oil pump. Yield: 2.475 g (29% of theory), green solid, freely soluble in dichloromethane, sparingly soluble in warm toluene. Spectroscopy: H- and C-NMR comply. X-ray structure determination (Figure A): atom connectivity and elemental composition in accordance with targeted structure.

By an analogous procedure as described in Example III-V, using dibutyl magnesium instead of diethyl zinc, tritylium tris{1,3-bis[3,5-bis(trifluoromethyl)phenyl]triazenido} magnesate(II) was obtained.

### Example VI

### Preparation of bis{1,3-bis[3,5-bis(trifluoromethyl)phenyl]triazenido} zinc(II) monoadduct with 1,3-bis[3,5-bis(trifluoromethyl)phenyl]triazene

To (1,3-bis[3,5-bis(trifluoromethyl)phenyl]triazenido}zinc(II) (Example III) 1 mole equivalent of 1,3-bis[3,5-bis(trifluoromethyl)phenyl]triazene (Example I) was added. The solution was stirred for 15 min at room temperature. The toluene was removed using a vacuum line (oil pump), yielding the product.

### Example VII

### Preparation of tritylium tris{1,3-bis[3,5-bis(trifluoromethyl)phenyl]triazenido} manganate(II)

Tritylium tris{1,3-bis[3,5-bis(trifluoromethyl)phenyl]triazenido} manganate(II) was prepared by the following procedure:

Anhydrous manganese dichloride (126 mg, 1 mmol) was dissolved 20 ml of dry THF under argon and cooled to −30-30° C. To the resulting solution was added 2.06 ml of an ethereal solution of methyllithium (1.6 M in ether, 3.3 mmol) via a syringe, stirred at −30° C. for 30 min, and subsequently 45 min at 0° C. Afterwards it was recooled to −30° C. and stirred at this temperature for another 15 min. To this solution was added a solution of 1.41 g of bis[3,5-bis(trifluoromethyl)phenyl]triazene (3 mmol, Example I) in 20 ml of diethyl ether at room temperature while stirring. After 30 min the cooling bath was removed, and stirring was continued for another 30 min at room temperature. Afterwards all solvents were removed by means of a vacuum line (oil pump). Subsequently 20 ml of diethyl ether were added and the reaction mixture was cooled to 0° C. Subsequently, chlorotriphenylmethane (279 mg) was dissolved in 15 ml of diethyl ether and added all at once via syringe. Afterwards, the reaction mixture was stirred overnight at ambient temperature and then decanted from the settled solids (discarded) after centrifugation. To the centrifuged supernatant hexane was added hexane drop by drop via syringe, until a weak turbidity occurred. The resulting reaction mixture was then kept at −30° C. for crystallisation. The crystalline product which separated was filtered off by a glass sintered Schlenk frit, washed with cold hexane (−10° C.) and dried on the vacuum line. The product contained single crystals yielding satisfactory X-ray reflexes, however a structural solution was not possible.

High resolution-MS: HR-MS (FABneg.): anion calculated: 1459.04; found: 1459.14; simulated isotopic distribution pattern corresponds exactly with calculated distribution. MS (FABpos): tritylium calculated: 243.12; found: 243.20.

### Example VIII

### Preparation of tetrakis-μ-[1,3-η-(1,3-bis-(3,5-bis(trifluoromethyl)phenyl)triazenido)]-tetrakis-[1,3-η-(1,3-bis-(3,5-bis(trifluoromethyl)phenyl)triazenido]-tetra-(μ³-fluoro)-di-(μ⁴-fluoro)-hexazincate²⁻, bistritylium salt

1,3-Bis(3,5-bis-(trifluoromethyl)phenyl)triazene (4,00 mmol; 1,877 g) was dissolved in 100 mL of anhydrous toluene in a Schlenk tube. The resulting solution was cooled to 0° C., and 2.05 ml of a solution of diethylzinc (2.05 mmol, 1 molar in hexanes) was added via syringe. Subsequently, the reaction mixture was agitated by means of a magnetic stirring bar at room temperature for 30 minutes and finally for 5 minutes at 100° C. Afterwards, the solution was recooled to 0° C., and sodium azide (65 mg, 1.00 mmol) was added in one portion. The resulting suspension was heated for 5 minutes to 100° C. Subsequently the reaction mixture was again cooled to 0° C. and a solution of tritylium tetrafluoroborate (330 mg, 1.00 mmol, dissolved in 10 ml CH₂Cl₂) was added. The reaction mixture was stirred overnight. Fluoride was liberated from the introduced tetrafluoroborate via azide substitution, to form a face fused dicubane-type hexafluorohexazincate, whereupon a precipitate formed. After settling, the supernatant was decanted. The remainder was taken up in 30 ml CH₂Cl₂ and filtered off from any insolubles. From the filtrate, dark green crystals of product, suitable for x-ray crystal structure determination, were grown at −30° C. Another crop of the dianionic biscubane-triazenido-fluorozincate complex was separated at −30° C. from the supernatant obtained from the first decantation. Yield: 30% of crystalline material, based on {1,3-bis(3,5-bis-(trifluoromethyl)phenyl)triazenido}zinc(II). Analysis: melting point: 117° C., decomp.; ¹H-NMR and ¹³C-NMR data comply. X-ray structure determination (Figure B): elemental composition and atom connectivity in accordance to the depicted structure (cocrystallisate with one molecule of dichloromethane and one molecule of alkane).

### Polymerization reactions in the presence of tritylium tris{bis[1,3bis(trifluoromethyl)phenyl]triazenido} zincate (II)

### Example IX

### Homopolymerization of Ethylene

A 2.0 l steel autoclave was charged with 700 ml pentamethylheptane (PMH). The catalyst, Me₂Si(Ind)₂ZrMe₂ (5 mL, 0.002M in toluene, 10 μmol) was injected via a catalyst dosage system and subsequently rinsed with 100 mL of PMH. Ethylene was then added to the reactor to obtain a pressure of 1.5 MPa. When the autoclave was brought to the polymerization temperature (51.1° C.), a solution of tritylium tris{1,3-bis[3,5-bis(trifluoromethyl)phenyl]triazenido} zincate (II) (10 mL, 0.002M, 20 μmol) C (Example V) was injected via the catalyst dosage system and the polymerization was performed under constant ethylene pressure. The temperature rose to 60.4° C. After 10 minutes of polymerization, the ethylene was vented off and the polymer was collected and dried in a vacuum oven at 70° C. Yield: 7.5 g of polyethylene. GPC (Gas Permeation Chromatography): M_{w}: 115 kg/mol, M_{w}/Mₙ: 2.0.

### Example X

### Homopolymerization of Ethylene at Atmospheric Pressure

To a Schlenk vessel containing a solution of 2,6-bis(N-(2,6-diisopropylphenyl)acetyliminopyridyl) iron(II) chloride (61 mg, 0.1 mmol) in 75 mL of toluene was added a toluene solution of tri(isobutyl) aluminium (TiBA) (2.5 mL, 0.1 M, 0.25 mmol). After bubbling through ethylene gas for 1 minute, a suspension of tritylium tris{1,3-bis[3,5-bis(trifluoromethyl)phenyl]triazenido} zincate (II) (170.8 mg, 0.1 mmol) (Example V) in 50 mL of toluene was added. The reaction was exothermic and polymer was formed. After 1 hour the reaction mixture was quenched with methanol. The PE was filtered off, washed with subsequently methanol and ligroin, and dried in vacuo at 70° C. Yield: 8.5 g of PE. GPC: M_{w}: 85 kg/mol, M_{w}/Mₙ: 17.4.

### Example XI

### Homopolymerization of Propylene

A 2.0 l steel autoclave was charged with 500 ml of PMH. Propylene was then added to the reactor to obtain a pressure of 0.82 MPa. The catalyst, Me₂Si(Ind)₂ZrMe₂ (20 mL, 0.002M in toluene, 40 μmol) was injected via a catalyst dosage system and subsequently rinsed with 350 mL of PMH. When the autoclave was brought to the polymerization temperature (50.4° C.), a solution of tritylium tris{1,3-bis[3,5-bis(trifluoromethyl)phenyl]triazenido} zincate (II) (40 mL, 0.002M, 80 μmol) (Example V) was injected via the catalyst dosage system and the polymerization was performed under constant propylene pressure. The temperature rose to 57.4° C. After 70 minutes the propylene was vented off and the polymer was collected and dried in a vacuum oven at 70° C. Yield: 5.7 g of polypropylene. GPC: M_{w}: 60 kg/mol, M_{w}/Mₙ: 1.8.

### Example XII

### Copolymerization of Ethylene and Propylene

A 2.0 l steel autoclave was charged with 500 ml of PMH. Propylene was then added to the reactor to obtain a pressure of 5 bar. The catalyst, Me₂Si(Ind)₂ZrMe₂ (5 mL, 0.002M in toluene, 10 μmol) was injected via a catalyst dosage system and subsequently rinsed with 350 mL of PMH while supplying propylene. When pressure became constant (5 bar), the propylene supply was stopped and the pressure was increased to 18.7 bar by adding ethylene. When the autoclave was brought to the polymerization temperature (50.2° C.), a solution of tritylium tris{1,3-bis[3,5-bis(trifluoromethyl)phenyl]triazenido} zincate (II) (10 mL, 0.002M, 20 μmol) (Example V) was injected via the catalyst dosage system and the polymerization was performed under constant ethylene pressure. The temperature rose to 55.3° C. After 10 minutes the monomers were vented off and the polymer solution was collected and dried in a vacuum oven at 70° C. Yield: 7.48 g ethylene-propylene copolymer containing 24.0 wt % of propylene. GPC: M_{w}: 81 kg/mol, M_{w}/Mₙ: 1.9.

### Polymerization reaction in the presence of tetrakis-η-[1,3-η-(1,3-bis-(3,5-bis(trifluoromethyl)phenyl)triazenido)]-tetrakis-[1,3-η-(1,3-bis-(3,5-bis(trifluoromethyl)phenyl)triazenido]-tetra-(μ³-fluoro)-di-(μ⁴-fluoro)-hexazincate²⁻, bistritylium salt

### Example XIII

### Homopolymerization of Ethylene

A 2.0 l steel autoclave was charged with 700 ml of PMH. The catalyst, Me₂Si(Ind)₂ZrMe₂ (5 mL, 0.002M in toluene, 10 μmol) was injected via a catalyst dosage system and subsequently rinsed with 100 mL of PMH. Ethylene was then added to the reactor to obtain a pressure of 15 bar. When the autoclave was brought to the polymerization temperature (51.1° C.), a solution of tetrakis-μ-[1,3-η-(1,3-bis-(3,5-bis(trifluoromethyl)phenyl)triazenido)]-tetrakis-[1,3-η-(1,3-bis-(3,5-bis(trifluoromethyl)phenyl)triazenido]-tetra-(μ³-fluoro)-di-(μ⁴-fluoro)-hexazincate²⁻, bistritylium salt (Example VI) (92 mg, 19 μmol) in toluene (30 mL) was injected via the catalyst dosage system and the polymerization was performed under constant ethylene pressure. The temperature rose to 60.3° C. After 10 minutes, the ethylene was vented off and the polymer was collected and dried in a vacuum oven at 70° C. Yield: 9.7 g of polyethylene. GPC: M_{w}: 160 kg/mol. M_{w}/Mₙ: 2.2.

### Polymerization reaction in the presence of tritylium tris{bis[1,3-bis(trifluoromethyl)phenyl]triazenido} manganese(II)

### Example XIV

### Homopolymerization of Ethylene

A 2.0 liter steel autoclave was charged with 600 ml of heptane. (2,6-Di-tert-butyl-4-methylphenoxy)di-1-butylaluminium (III) (DiBAL-BOT, 0.8 ml, 0.5 M, 400 μmol) and the catalyst, Me₂Si(Ind)₂ZrMe₂ (5.0 ml, 0.002 M, 10 μmol) were respectively injected via a catalyst dosage system and subsequently rinsed with 200 ml of heptane. Ethylene was then added to the reactor to obtain a pressure of 1.5 MPa. When the autoclave was brought to the polymerization temperature (50.4° C.), a solution of tritylium tris{1,3-bis[3,5-bis(trifluoromethyl)phenyl]triazenido} manganese(II) (10 ml, 0.001 M, 10 μmol) was injected via the catalyst dosage system and the polymerization reaction was performed under a constant ethylene pressure. The temperature rose to 50.5° C. After 7 minutes of polymerization, the ethylene was vented off and the polymer was collected and dried in a vacuum oven at 60° C. Yield 0.55 g of polyethylene.

### Polymerization reactions in the presence of tritylium tris{bis[1,3-bis(trifluoromethyl)phenyl]triazenido} magnesium(II)

### Example XV

### Homopolymerization of Ethylene

A 2.0 liter steel autoclave, containing a stirrer (1350 rpm), was charged with PMH. The polymerization reaction was carried out under a constant flow of ethylene (0.7 MPa and 50° C. DIBAI-BOT (400 μmol) was added as a scavenger together with 800 ml of PMH to the reactor and the reactor was pressurized with ethylene. When the reactor had reached the desired temperature and pressure the catalyst (rac-Me₂Si(Ind)₂ZrMe₂, 2 mL, 0.01 M in toluene) and tritylium tris{bis[1,3-bis(trifluoromethyl)phenyl]triazenido} magnesium(II) (2 equivalents in toluene) were added subsequently in 100 mL PMH each. After 10 minutes of polymerization the ethene feed was stopped and the reaction mixture was collected and dried in vacuo at 100° C. Yield: 3.52 g of polyethylene. GPC: Mₙ: 56 kg/mol, M_{w}: 155 kg/mol, M_{w}/Mₙ: 2.8.

### Polymerization reactions in the presence of bis{1,3-bis[3,5-bis(trifluoromethyl)phenyl]triazenido} zinc(II) monoadduct with 1,3-bis[3,5-bis(trifluoromethyl)phenyl]triazenide

### Example XVI

### Homopolymerization of Ethylene

A 2.0 liter steel autoclave was charged with 600 ml heptane. The 0.8 ml DiBAL-BOT (0.5 M, 400 μmol) and the catalyst, Me₂Si(Ind)₂ZrMe₂ (5.0 ml, 10 μmol) were respectively injected via a catalyst dosage system and subsequently rinsed with 200 ml of heptane. Ethylene was then added to the reactor to obtain a pressure of 1.5 MPa. When the autoclave was brought to the polymerization temperature (50.6° C.), a solution of bis{1,3-bis[3,5-bis(trifluoromethyl)phenyl]triazenido} zinc(II) monoadduct with 1,3-bis[3,5-bis(trifluoromethyl)phenyl]triazenide (20 ml, 0.001 M, 20 μmol) was injected via the catalyst dosage system and the polymerization reaction was performed under a constant ethylene pressure. The temperature rose to 50.7° C. After 7 minutes of polymerization, the ethylene was vented off and the polymer was collected and dried in a vacuum oven at 60° C. Yield: 0.66 g of polyethylene.

1. Catalyst composition comprising a salt of a non- or weakly coordinating anion, said non- or weakly coordinating anion comprising at least one metal or metalloid ion M with valency v+, v representing an integer between 1 and 5, and at least one bidentate ligand coordinating to this metal or metalloid ion, and a catalyst that can be activated by said non- or weakly coordinating anion, characterized in that said bidentate ligand is a bidentate monoanionic ligand of formula (I):
(R¹_{q}A¹-X-A²R²ᵣ)⁻, (I)
wherein
X represents a bridging moiety;
A¹ and A² are each independently chosen from the group comprising N, O, P, S, and C;
R¹ and R² are each independently chosen from the group comprising an optionally substituted linear or branched (hetero) alkyl group, an optionally substituted (hetero) aryl group, and a Si containing group; and q and r each independently represent an integer with 0≦q, r≦2.

2. Catalyst composition according to claim 1, wherein the non- or weakly coordinating anion has formula (II):
[LₙM(R¹_{q}A¹-X-A²R²ᵣ)ₘ]^{w-} (II)
wherein
M, X, A¹, A², R¹, R², q, r, and v are defined as above;
L represents a ligand to M or a bridging moiety between two M atoms;
n is an integer with 0≦n≦5;
m is an integer with 1≦m≦6;
n+m>v;
n+m≦6;
w is an integer with 1≦w≦3; and
the ligands (R¹_{q}A¹-X-A²R²ᵣ)⁻ may be the same or different.

3. Catalyst composition according to claim 1, wherein the non- or weakly coordinating anion has formula (III):
[L¹_{z1}L²_{z2}Mₓ(R¹_{q}A¹-X-A²R²ᵣ)_{y}]^{w-} (III)
wherein
M, X, A¹, A², R¹, R², q, r, v and w are defined as above;
L¹ is an end-capped or corner-bridging bidentate ligand;
L² is a core building ligand;
x is an integer with 2≦x≦10
y is an integer with 0≦y≦20;
z1 and z2 are integers with 0≦z1, z2≦20;
y+z1+z2>xv; and
the ligands (R¹_{q}A¹-X-A²R²ᵣ)⁻ may be the same or different.

4. Catalyst composition according to claim 1, wherein M represents a metal of any one of the Groups 2, 3, 4, 5, 6, 7, 8, 9, 10, 11 or 12, an actinide metal or a lanthanide metal.

5. Catalyst composition according to claim 4, wherein M represents Zn.

6. Catalyst composition according to claim 1, wherein the charge of the bidentate monoanionic ligand of formula (R¹_{q}A¹-X-A²R²ᵣ)⁻ is delocalized over the moiety A¹-X-A².

7. Catalyst composition according to claim 1, wherein (R¹_{q}A¹-X-A²R²ᵣ)⁻(R⁵N—N—NR⁶)⁻, wherein R⁵ and R⁶ are each independently chosen from the group comprising an optionally substituted linear or branched (hetero) alkyl group, an optionally substituted (hetero) aryl group, and a Si containing group.

8. Catalyst composition according to claim 1, wherein the salt of the non- or weakly coordinating anion comprises a cation chosen from the group comprising N,N-dimethylanilinium, R⁷₃Si, wherein R⁷ represents an optionally substituted linear or branched (hetero) alkyl group, an optionally substituted (hetero) aryl group, or a Si containing group, triphenylcarbenium, and Li⁺.

9. Catalyst composition according to claim 1, wherein the catalyst that can be activated by said anion is a single site catalyst.

10. Process for the polymerization of olefins, wherein at least one catalyst composition according to claim 1 is used.

11. Process according to claim 10, the process resulting in the formation of High Density PolyEthylene (HDPE), Low Density PolyEthylene (LDPE) or Linear Low Density PolyEthylene (LLDPE).

12. Process according to claim 10, the process resulting in the formation of ultra-high molecular weight polyethylene (UHMWPE), the UHMWPE having a weight average molecular weight, as measured by Size Exclusion Chromatography (SEC), of more than 800,000 g/mol.

13. Process according to claim 10, the process resulting in the formation of PolyPropylene (PP), Random Copolymer Polypropylene (RCP) or Elastomer Modified PolyPropylene (EMPP).

14. Process according to claim 10, the process resulting in the formation of amorphous or rubbery copolymers based on ethylene and at least one other α-olefin.

15. Process for the preparation of a compound of formula (IV):
[C]^{c+}ₗ[LₙM(R¹_{q}A¹-X-A²R²ᵣ)ₘ]^{w-} (IV)
wherein
M, X, A¹, A², R¹, R², q, r, v, L, n, m and w are defined as for the compound of formula (II); [C]^{c+} is a cation;
c=1 or 2;
l is an integer with 1≦l≦3;
l=w/c, and
the ligands (R¹_{q}A¹-X-A²R²ᵣ₎⁻ may be the same or different; the process comprising the following steps:
i) contacting an alkylated compound comprising the unit MR⁸ₜ, wherein R⁸ is an optionally substituted linear or branched (hetero)alkyl group, an optionally substituted (hetero) aryl group, or a Si containing group, and t is an integer with 1≦t≦4, with (R¹_{q}A¹-X-A²R²ᵣ)H to form a compound of formula M(R¹_{q}A¹-X-A²R²ᵣ)ᵤR⁸ₜ₋ᵤ, wherein u is an integer with 1≦u≦4;
ii) contacting (R¹_{q}A¹-X-A²R²ᵣ)H with [K]^{k+}Hₖ in a solvent that is not capable of donating an electron pair, to form (R¹_{q}A¹-X-A²R²ᵣ)ₖ[K]^{k+}, wherein K is an alkali or alkaline earth metal, and k is 1 or 2
iii) contacting the product obtained in i) with the product obtained in ii), resulting in the formation of [K]^{k+}ₗ[LₙM(R¹_{q}A¹-X-A²R²ᵣ)ₘ]^{w-}
iv) exchanging [K]^{k+} for [C]^{c+}, resulting in the formation of [C]^{c+}ₗ[LₙM(R¹_{q}A¹-X-A²R²ᵣ)ₘ]^{w—}.

16. Compound of formula (V):
[C]^{c+}ₗ[LₙM(R⁵—N—N—N—R⁶)ₘ]^{w-} (V)
wherein
M, L, n, m, [C]^{c+}, c, l and w are defined as for the compound of formula (IV);
R⁵ and R⁶ are each independently chosen from the group comprising an optionally substituted linear or branched (hetero) alkyl group, an optionally substituted linear or branched (hetero) aryl group, and a Si containing group.

17. Compound of formual (VI):
[C]^{c+}ₗ[L¹_{z1}L²_{z2}Mₓ(R⁵N—N—N—R⁶)_{y}]^{w-} (VI)
wherein
M, R⁵, R⁶, [C]^{c+}, c, l and w are defined as for the compound of formula (V);
L¹, L², z2, x, y, l and v are defined as for the compound of formula (III);
the ligands (R1qA1-X-A2R2r)- may be the same or different.

18. Compound according to claim 16, wherein M represents Zn.

19. Compound according to claim 17, wherein M represents Zn.
